(19) United States
(12) Patent Application Publication
(10) Pub. No.: US 2013/0148835 A1
(43) Pub. Date: Jun. 13, 2013

(54) Speaker With Spheroidal Acoustic Emitter Housing

(71) Applicants: Patrick G. Looney, Bear Lake, MI (US); James R. Reed, Bear Lake, MI (US)

(72) Inventors: Patrick G. Looney, Bear Lake, MI (US); James R. Reed, Bear Lake, MI (US)

(21) Appl. No.: 13/706,016

(22) Filed: Dec. 5, 2012

Related U.S. Application Data
(60) Provisional application No. 61/630,414, filed on Dec. 12, 2011.

(51) Int. Cl. H04R 1/28

(52) U.S. Cl. CPC H04R 1/28
USPC 381/345

(57) ABSTRACT

An improved speaker in which a single electro-acoustic driver is mounted in a sound emitter cabinet with a spheroidal rear acoustic emitter wall, with the driver face exposed and mounted on a driver-mounting face of the cabinet and the driver body enclosed in the spheroid cabinet. The spheroidal rear emitter wall is spaced from and surrounds the driver body to receive the back wave and to responsively emit audible, clear sound from the cabinet wall to the surrounding listening area in complement to the primary sound wave from the driver face. The speaker cabinet is rigidly supported via the driver-mounting face such that the spheroidal rear emitter wall is suspended in air out of contact with surrounding surfaces.

### RELATED APPLICATIONS/PRIORITY BENEFIT CLAIM

This application claims the benefit of U.S. Provisional Application No. 61/630,414 filed Dec. 12, 2011 by the same inventors (Looney and Reed), the entirety of which provisional application is hereby incorporated by reference.

### FIELD

The subject matter of the present application is in the field of acoustic speakers comprising cabinets or enclosures that house electromechanical speaker elements, for playing audible sound including music.

### BACKGROUND

Conventional speaker housing design places an electromechanical sound-emitting speaker or “driver” in a sound-deadened cabinet or housing. The driver face is exposed and the remainder of the driver is enclosed in the cabinet, in order to prevent the speaker backwave (basically all sound output from portions of the driver other than the face) from interfering with the primary sound wave emitted forwardly from the driver face. An Aug. 24, 2007 internet article, titled “Speakers Newsletter Issue #77: Speaker Cabinet Theory”, summarizes the problem as follows: “The main purpose of a speaker cabinet is to cut down on rear output that creates sound cancellations which can have a detrimental effect on a speaker's performance.”

This conventional speaker construction tends to limit sound quality, especially at points of listening reference that are off-axis from the driver face. Various efforts have been made to optimize the sound quality from such speakers, including using multiple drivers mounted in various locations and orientations in a single cabinet; optimizing the placement and orientation of multiple speakers in a listening area; using premium materials for drivers and wiring, including precious metals; employing digital sound processing electronics upstream of the driver; and supplementing the speakers with special listening-room treatments such as bass traps and diffuser panels.

The result generally has been increasingly expensive and complex speaker systems for achieving relatively small increases in sound quality.

### BRIEF SUMMARY

We have invented a speaker designed to use, and to emit sound in response to, the back wave of a conventional single-point driver, in a manner that complements the primary forward sound wave from the driver face. The speaker cabinet is designed to serve as an audible secondary source of sound transmission, configured in such a way as to serve the purpose, directly or indirectly, of using the back wave emission from a primary sound radiation source to produce an emission of sound wave signals to a listening area. In broad terms, the cabinet serves as a secondary sound wave transmitter. Furthermore, it does so in a manner that complements the primary sound radiation source, i.e. the driver face and its primary sound transmission. The speaker cabinet is a passive emitter in the sense that it is not itself powered, but is responsive to the energy of the back wave from the driver to emit sound.

“Backwave” is used herein to mean sound emitted from the driver other than the primary sound wave from the driver face, in particular sound emitted from surfaces of the speaker/driver element that are enclosed in the cabinet.

The terms “speaker” and “driver” are often used interchangeably in the art. For clarity, “speaker” will be used herein to mean the combination of a driver and its cabinet or housing, while “driver” will refer to the sound generating device mounted in the housing (sometimes also referred to as a “loudspeaker”). “Driver” generally includes any electro-acoustic or electro-mechanical transducer or other type of driver that produces or reproduces audible sound, including musical sound, in response to electrical signals, with a primary forward sound wave from its face and a back wave behind its face.

The speaker comprises a generally spherical or “spheroid” cabinet or housing with an exterior driver-mounting face on which the driver face is mounted and exposed, and a generally hollow interior in which the remainder of the driver is enclosed. The speaker cabinet is made from any material capable of responding to the acoustic back wave from the driver by emitting clear sound, rather than dampening or deadening the sound, and thus forms a generally spherical or spheroidal acoustic emitter surface for the back wave output of the driver. Possible materials include, but are not limited to, polymers, fiber composites, different types of wood, metals, and hardened paper- or cloth-based materials—essentially any material that can be molded, machined, or otherwise formed into a hollow spheroid shape capable of functioning as an acoustic emitter surface for the back wave from a driver mounted therein.

In a further form, the spheroid portion of the speaker cabinet ends at the driver-mounting face, which is the only acoustically significant non-spheroid surface on the cabinet. The driver-mounting face may be essentially coextensive with the driver face, for example a portion of the cabinet or a stable interface structure providing just enough surface to mount the periphery of the driver, such that the driver face is the only acoustically significant non-spheroid surface on the cabinet. Alternately, the driver-mounting face may be larger than and extend beyond the driver face, for example a non-spheroidal, non-acoustic mounting face of larger area than the driver face, and in a preferred form a flat mounting face essentially co-planar with the driver face. It is currently preferred that a larger driver-mounting face be made from a non-acoustic (acoustically deadening) material, so that it is not an acoustic emitter surface with the spheroidal rear emitter wall of the cabinet. However, it might be possible to make a larger driver-mounting face from an acoustic emitter material that emits sound responsive to the back wave, if it does not significantly interfere with the sound emitted by the remainder of the cabinet.

In a further form, the speaker cabinet is supported at the driver-mounting face, suspended out of contact with surrounding surfaces. In a further form, the driver-mounting face comprises a flat stable face, plate or ring that creates an acoustically non-responsive “null” point between the driver and the spheroidal back-wave emitter portion of the cabinet. The support comprises a rigid member, for example a frame or a cantilever stand, secured to and/or forming part of the driver-mounting face such that the spheroid rear emitter portion of the cabinet is suspended in the air in substantially rigid, stable fashion via the driver-mounting face, out of contact with surrounding surfaces for unhindered vibration conductance from the emitter surface. This allows the spheroid rear emitter cabinet to provide stable, accurate reproduction of the sound from the driver back wave, with three-dimensional accuracy across the full audio spectrum.

“Generally spherical” or “spheroid/spheroidal” as used herein include both perfect spheres as well as shapes that are not perfectly spherical, and shapes whose surface portions approximate a section (preferably half or more, although less than half is believed to be functional) of a sphere or spheroid behind the speaker's driver-mounting face. Accordingly, “spheroid” will be used as shorthand for sections of spherical, spheroid (having elongated or irregular or generally elliptical curved surfaces), ovoid (egg-shaped), and similar three-dimensional, generally continuously curved shapes. It also includes cabinets with more than one distinct spheroidal portion. In general it is believed to be preferable that the inner surface of the cabinet wall have generally the same or similar curvature/shape as the outer surface of the cabinet wall, but it is further believed that the curvature/shape of the outer surface of the rear emitter wall of the cabinet is the most important for emitting the secondary sound wave in response to the backwave.

In a further form, the invention comprises a hollow speaker cabinet having a spheroidal rear wall made from an acoustic emitter material, with a driver mounted to the front of the cabinet via a non-acoustic, non-spheroidal (preferably flat) stable mounting face by which the cabinet is also rigidly supported out of contact with surrounding surfaces, with the driver face exposed and with the backwave-producing driver body enclosed by the spheroidal rear emitter wall.

In a further form, the invention comprises a method for using the back wave from an electro-acoustic driver, comprising directing the back wave from the driver into the hollow interior of a spheroid emitter cabinet rigidly supported out of contact with surrounding surfaces by its driver-mounting face, such that the surface of the spheroid cabinet functions as an acoustic emitter for the back wave.

These and other features and advantages of the invention will become apparent from the detailed description below, in light of the accompanying drawings.

### BRIEF DESCRIPTION OF THE DRAWINGS

FIG. 1 is a schematic side elevation view, in partial section, of a conventional prior art speaker with a deadened cabinet, and of the primary and back sound waves from the driver mounted in the housing.

FIG. 2 is a schematic side elevation view, in partial section, of a speaker according to the present invention, schematically representing the sound emitted from the speaker.

FIG. 3 is a schematic side elevation or top plan view of the speaker of FIG. 2, in partial section, schematically representing the angular sectors in which sound is emitted from the speaker.

FIGS. 4 and 4A are front perspective views of a speaker according to the schematic representation of FIG. 2, one in exploded assembly (FIG. 4) and one assembled (FIG. 4A).

FIG. 5 is a side elevation view, in partial section, of an alternate speaker according to the invention, made with an irregularly curved spheroid cabinet.

FIGS. 6, 6A, and 6B are schematic side elevation and perspective views of an alternate speaker similar to the speaker in FIGS. 2 and 4A, but with a hemispherical cabinet and larger driver-mounting face.

FIG. 7 is similar to FIG. 2, but shows a speaker cabinet with a port in the side opposite the driver.

### DETAILED DESCRIPTION

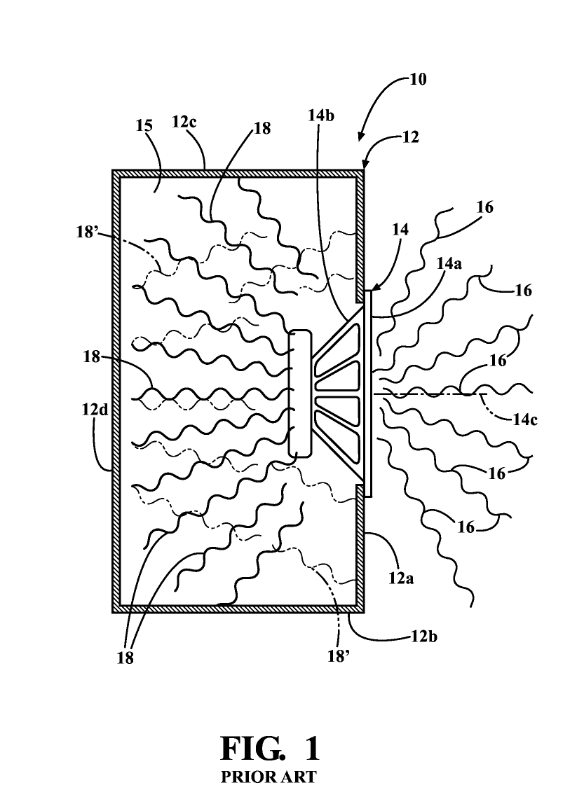

Referring to FIG. 1, a prior art speaker of conventional type is illustrated generally at 10, and includes a cabinet or housing 12 (hereafter “cabinet”) and an electro-acoustic speaker element or driver 14 mounted in the cabinet. Drivers such as 14 generally have a flat front face 14a and a conical rear body 14b. Driver 14 is mounted with its front face 14a exposed on a flat front face 12a of the cabinet, and with its rear body 14b contained within the interior 15 of the cabinet. Driver 14 is provided with electrical power and electro-acoustic signals in known fashion, for example by one or more cables (not shown), in response to which the driver produces audible sound from the speaker 10. The interior 15 of cabinet 12 can be hollow (illustrated for clarity), or it might also contain sound-deadening material, structures or geometries; electronics, additional drivers, and other features known to those skilled in the art.

The sound emitted by driver 14 includes, for purposes of this application, two main components: a primary or front wave emitted away from the driver face 14a in what is believed to be a primarily conical, forward-directed waveform centered on a driver axis 14c, the front wave represented schematically at 16; and, what is believed to be a more or less omni-directional secondary or back wave from the driver body 14b in all other directions behind the driver face, the back wave represented schematically at 18 inside the cabinet.

Some or all of the front, bottom, top, rear and side walls 12a, 12b, 12c, and 12d (side walls are omitted in the section view) of cabinet 12 are typically flat surfaces made from a sound-dampening or sound-deadening material, and/or are modified with sound-deadening materials or treatments. The acoustic deadening properties of the walls and internal surfaces of cabinet 12 are intended to prevent the driver's back wave 18 from resonating or being emitted outwardly from the walls of the cabinet, which would interfere with and reduce the quality of the primary sound wave 16 emitted from the driver face. Portions 18′ of the back wave, partially deadened and/or re-oriented randomly from their originally emitted pattern, are illustrated schematically at 18′, and ideally are trapped inside cabinet 12 to prevent them from interfering with the front wave in the listening area. The goal in this representative prior art speaker 10, therefore, is to kill the back wave 18 and allow only the primary wave 16 emitted directly from the driver face to be heard by listeners. Prior art speaker cabinet 12 typically rests on a support surface (table, floor, etc.) via its flat bottom surface, i.e. it is self-supporting.

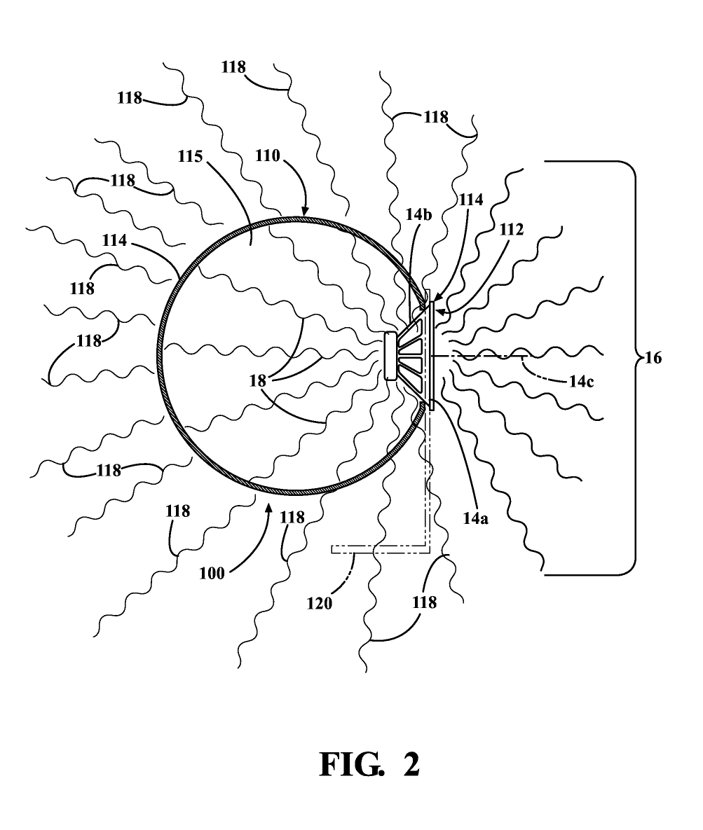

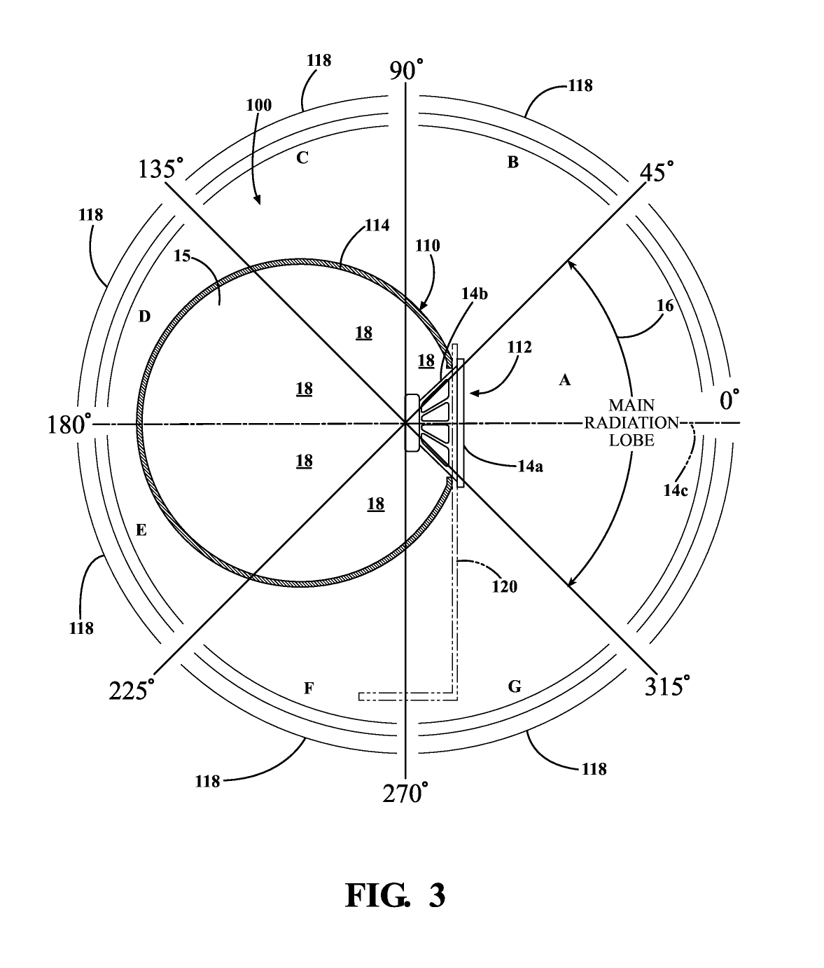

Referring now to FIGS. 2 and 3, a speaker 100 according to the present invention is shown in exemplary form, in order to teach how to make and use the claimed invention. Speaker 100 includes a hollow spheroid housing or cabinet 110 having a driver-mounting face 112 at the junction of the periphery of the driver and a spheroidal wall 114 defining a hollow interior 115; a conventional electro-acoustic driver 14; and a rigid speaker support 120 connected to and/or forming part of the driver-mounting face. Driver 14 may be any known type of driver 14 used in prior art speakers such as 10 illustrated in FIG. 1. Spheroidal rear wall 114 comprises a material that is acoustically emittive, i.e. responsive to the back wave from driver 14 to function as an intentional acoustic emitter of the back wave to the surrounding listening area. We know of no limitations on the material used for the spheroidal wall of cabinet 110, or on the thickness of the wall, provided music and other audible sound played via the driver is clearly emitted by, or can be clearly heard from, the spheroidal rear wall of cabinet 110, with as little dampening, deadening, or deflecting of the back wave as possible. In the illustrated example of FIGS. 2 through 4, cabinet 110 is made from an acrylic polymer approximately ⅛ of an inch in thickness or less. Greater and lesser thicknesses, both absolute and relative to the overall volume of the cabinet, are also believed possible without known limitation, depending on the acoustic emitter properties of the material used.

FIG. 2 schematically shows primary, forward-directed sound wave 16 emitted from the driver face 14a on driver axis 14c, believed to be in a generally conical radiation pattern known to those skilled in the art. Back wave 18 radiates from the driver body 14b enclosed in cabinet 110, transmitted to the interior surface of spheroidal rear wall 114 in an omni-directional, generally spherical pattern believed to be known to those skilled in the art. Wall 114 is made from an acoustic emitter material that transmits back wave 18 with little distortion or dampening, such that the back wave 18 is emitted to the surrounding listening area from spheroidal cabinet wall 114 as audible secondary sound emission 118.

The secondary sound emission 118 illustrated as emanating from spheroidal cabinet wall 114 represents the sound emitted from the surface of wall 114 in response to the back wave 18 from the interior 115 of the cabinet to the surrounding listening area; the exact mechanics are unknown to us. That the original back wave 18 is somehow modified or otherwise made complementary to the front wave 16 by the spheroid emitter surface of cabinet 114 is illustrated schematically by the offset of the lines 118 relative to lines 18 in FIG. 2.

FIG. 3 represents sectors of sound emission A, B, C, D, E, F, G from speaker 100. It is believed that the primary sound wave 16 from driver face 14a will expand in a conical manner away from the driver-mounting front face 112 of speaker 100 in sector A, while the secondary sound wave 18 emitted by spheroid cabinet 110 in sectors B, C, D, E, F, and G in response to the driver back wave will expand in a manner that “fills” the listening area with sound in a pattern that completes and complements the primary sound wave. The resulting, apparently spherical, directionally consistent, total sound emission from speaker 100 is a complementary sum of total sound emitted by the driver, combining the primary and secondary emitted sound waves 16 and 18/118 into what is believed to be an essentially unitary expanding spherical wave with minimal overlap, distortion, or interference.

Testing has indicated that sound quality from all listening angles around a speaker such as illustrated at 100 is of very uniform quality, with little loss in quality when comparing “off-axis” secondary sound 118 produced by back wave 18 in sectors B, C, D, E, F, and G to the primary “on-axis” sound of the front wave 16 from driver face 14a in sector A.

FIG. 3 can represent either a side elevation view or a top view, since the illustrated speaker 100 is essentially symmetrical except for the driver face 14a exposed on a side of the spheroidal cabinet 110. In a further aspect of the invention, spheroidal sound emitter cabinet 110 is isolated from surrounding surfaces by support 120. In the illustrated example, a cantilever support 120 is shown in phantom lines, connected to the speaker cabinet only at the driver-mounting face 112 around the driver to hold the cabinet rigidly and stably above or spaced from an environmental support surface such as a table, wall, ceiling, desk, or floor. The shape and nature of speaker support 120 may vary, and can include not only a free-standing vertical support for resting on a level surface as shown, but wall- and ceiling-mount brackets, frameworks around the driver face, and others, without limitation, provided that the cabinet is rigidly supported at its flat, null-point driver-mounting face such that the spheroidal rear emitter wall 114 is suspended out of contact with surrounding surfaces. It is also possible to orient the driver-mounting face, and thus the driver face, in any direction desired, and so it should be understood that terms such as “side” and “front” are not intended to be limiting, and that the orientation of the speaker 100, of the driver face, and of the speaker support axis 120 can vary. “Rear” is used to describe the spheroidal emitter wall portion 114 because it responds to the backwave from the rear of the driver.

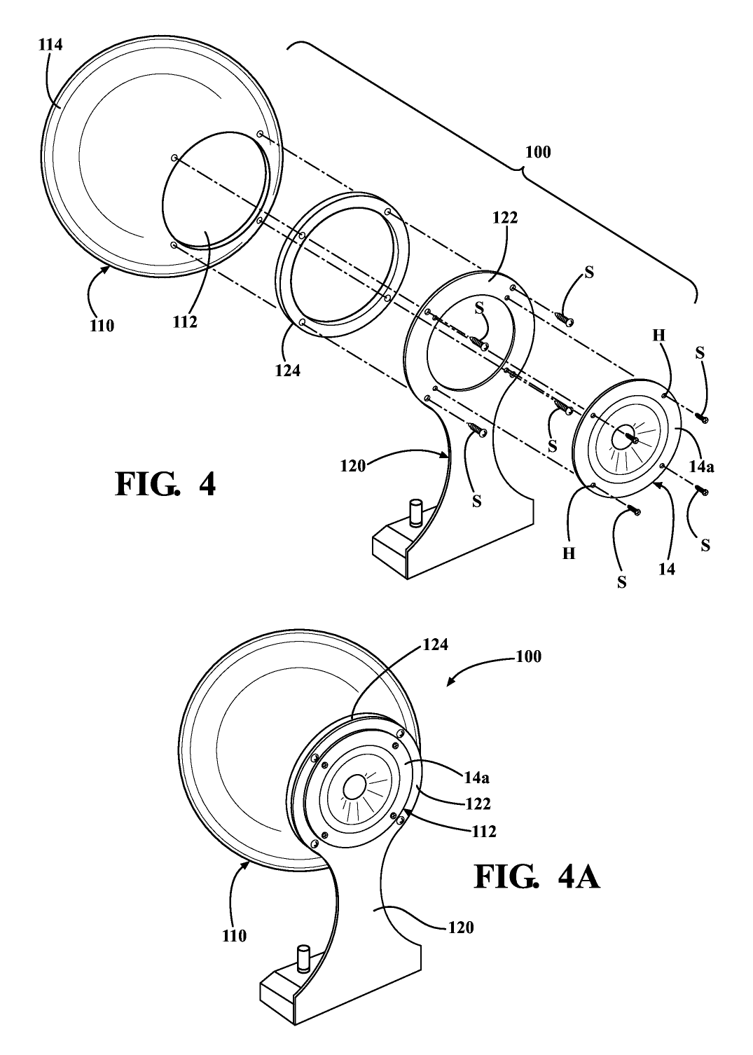

FIGS. 4 and 4A illustrate an actual speaker 100 according to the invention, for clarity omitting the known sound signal and power supply wiring and electronics normally associated with driver 14. Speaker 100 includes a driver 14, a spheroid emitter cabinet 110 (spherical in this example) with a driver-mounting face 112 comprising in part a flat area around a driver opening in a side or “front” of the sphere, a spherical rear emitter wall 114, and a cabinet support 120 connected at the driver-mounting face 112. In the illustrated example, driver-mounting face 112 is partly defined by a flat mounting ring 122 and a flat mounting flange 124 at the upper end of support 120. In the illustrated example, ring 122 and flange 124 are made from metal and/or polymer materials different than the acrylic rear emitter wall 114, although they are not limited to any particular material. While circular ring and flange structures are shown to match the typically circular peripheral flange of driver 14, non-circular “rings” and flanges are also possible. Support 120 supports the cabinet 110 off the ground and also provides a secure mount for driver face 14a on the side of the cabinet, for example using the illustrated screws S through mating holes H in the driver face and the mounting ring/flange structure. The mounting ring and mounting flange are in turn secured to the side/front face 112 of the cabinet 110 with additional screws S. The illustrated speaker 100 shows a driver-mounting face 112 that is essentially coextensive with the driver face 14a; i.e. the driver face essentially covers the driver-mounting face 112 of the speaker cabinet, being the only significant non-spheroidal (in this example, flat) surface on the cabinet. The illustrated cabinet is shown in a transparent acrylic material.

It may be possible to make a speaker having a larger non-spheroidal or flat driver-mounting face that is also an acoustic emitter. While this is believed to some negative effect on overall sound quality from the speaker, it might not be significantly negative to many listeners. In general the non-spheroidal (and preferably flat) driver-mounting face's generally co-planar relationship to the face of the driver mounted therein, between the primary sound wave and the backwave, along with the spheroidal rear emitter wall that captures and secondarily emits the backwave, is believed to produce an acoustic null point relative to the driver regardless of the material used for the driver-mounting face.

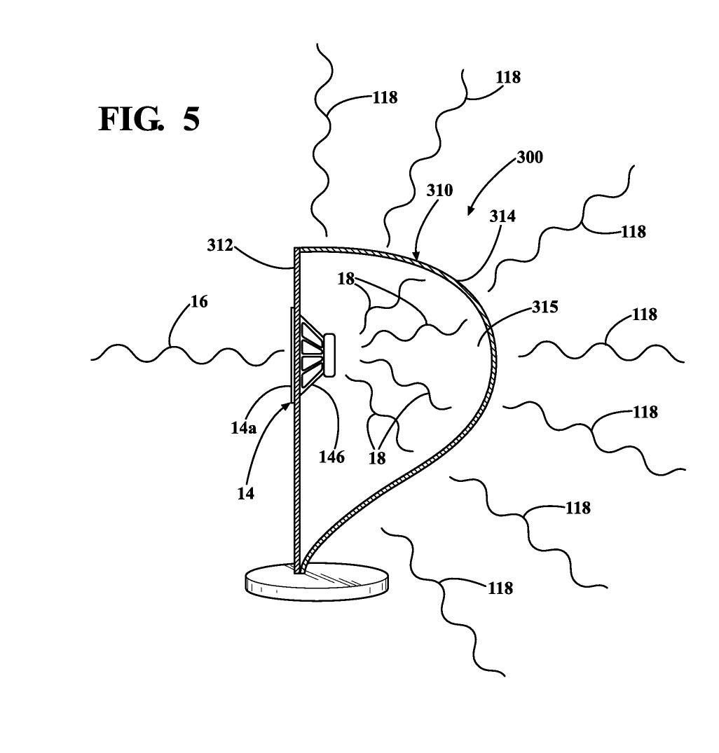

FIG. 5 shows a speaker 300 with an irregularly curved spheroidal sound-emitting cabinet 310, and a non-spheroidal (flat) front driver-mounting face 312 larger than the face of the driver 14. The periphery of the driver is mounted directly to the driver-mounting face 112, rather than through intermediate flange or ring structure as in FIGS. 4 and 4A. Rather than a distinct support such as 120 in the previous Figures, speaker 300 is supported by the driver-mounting face 112, which functions as a combined support and driver-mounting face, extending in the illustrated example to a base plate adapted to rest on a table-top. As in earlier Figures, substantially all of the spheroid rear emitter wall 114 of the speaker cabinet is rigidly supported out of contact with surrounding surfaces.

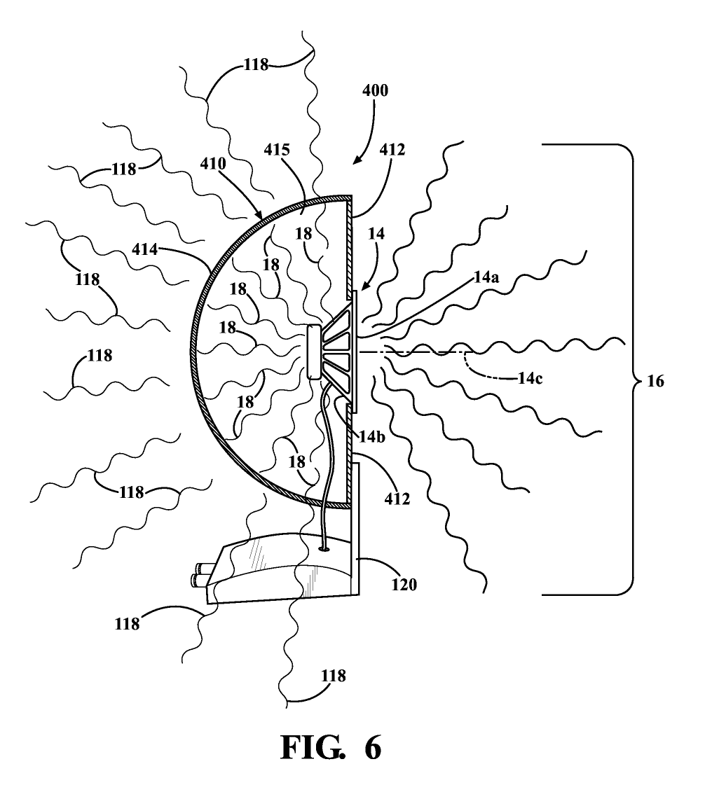

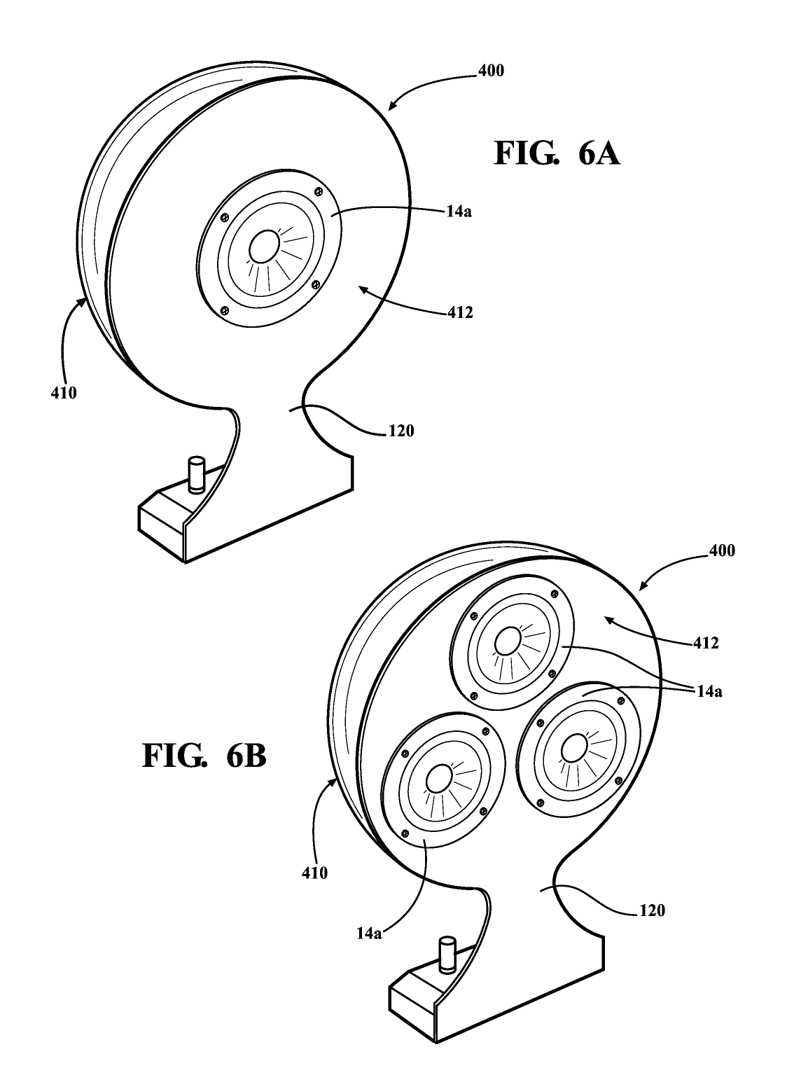

FIGS. 6, 6A, and 6B schematically show a speaker 400 with a more minimally spheroidal speaker cabinet 410, with the rear emitter wall comprising approximately half a sphere, and with a large, substantially flat, sound-deadening front face 412 mounting the driver 14. It is believed that half of a spheroid is the optimal minimum for the sound-emitting speaker cabinet, although it should be possible to use spheroid speaker cabinets with a curved rear emitter wall that encompasses a spheroid section less than half a sphere, but that would, if extended along its general radius of curvature, form half or more of a spheroid as in the examples of FIGS. 1 through 6. A rigid support 120 is shown connected to and extending below the larger driver-mounting face 412 in a variation of the extended driver-mounting face 312 in FIG. 5. FIG. 6B illustrates the speaker 400 modified with multiple drivers 14, which may be advantageous for some end uses, for example in theater speakers.

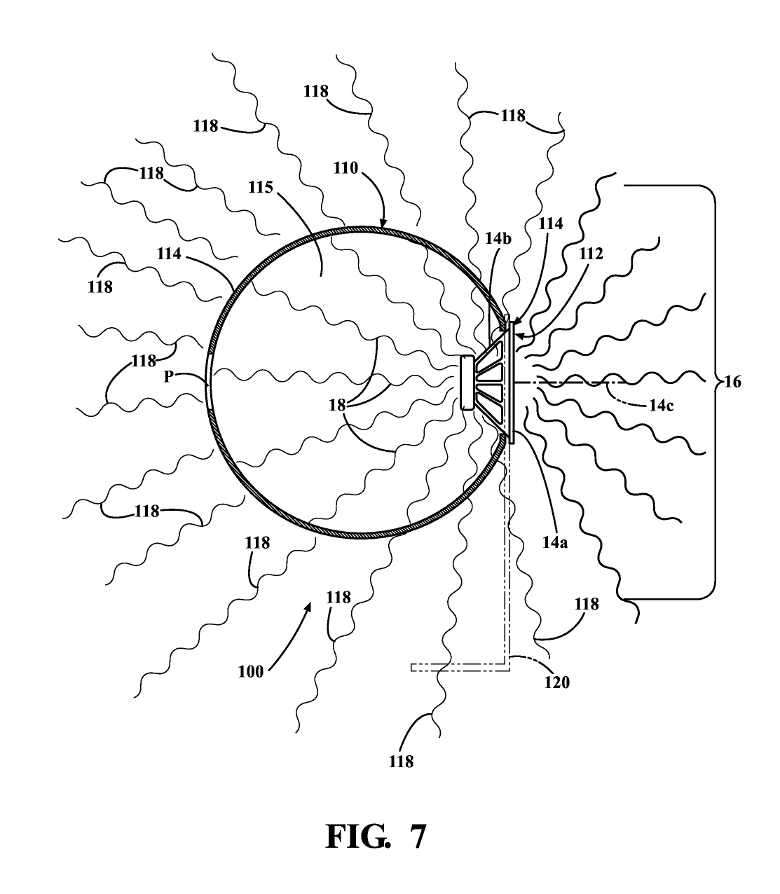

FIG. 7 illustrates a variation of the free-standing spheroidal speaker cabinet of FIG. 2, in which the cabinet wall has been ported at P to allow the speaker cabinet to emit sound further into the bass region of the audible spectrum, and at a higher SPL. By porting the cabinet at various locations it is possible to alter the driver's impedance vs. frequency response characteristics. In the illustrated example of FIG. 7, port P is aligned with the driver axis, to the rear of the driver, but other porting locations are possible. Also, although a single port is shown, it should be possible to use multiple ports, provided the surface area of the spheroid cabinet wall is greater than the surface area of the open ports.

### Description of Operation

In operation, the speaker 100 is used by supplying electrical power and sound signals to driver 14 in known fashion, for example signals representing music. Driver 14 then produces, again in known fashion, a primary sound wave 16 from its face 14a, and a back wave 18 from the driver body 14b enclosed within the speaker cabinet 110 behind the driver face. Unlike prior speakers, however, spheroid speaker cabinet 110 responds to back wave 18 impinging the interior surface of spheroidal rear emitter wall 114 by emitting back wave 18 to the surrounding listening environment as an audible, high quality, secondary sound wave 118 (FIG. 2). Moreover, secondary sound wave 118 complements primary sound wave 16 from the driver face, by filling in the remainder of the listening area with a spheroidal sound wave mating with (rather than interfering with) the conical primary wave. The more closely that the driver-mounting face of the speaker cabinet corresponds to the driver front face, and thus the closer the spheroidal cabinet wall comes to the driver face, the better the complement. Even with larger flat front faces, however, such as shown in FIGS. 5, 6, and 7, the sound quality from speaker 100 is a substantial improvement over conventional backwave-killing speakers. The spheroid speaker cabinet, in particular the spheroid rear wall 114 which provides the secondary emitter surface, is stably supported at the flat driver-mounting face 112 by a rigid support that holds the secondary emitter surface out of contact with surrounding surfaces in the listening environment, and that provides a non-emitter acoustic null point between the driver front face and the emitter portion of the cabinet.

All of the illustrated embodiments show single-point sound emitters (single drivers with a single primary sound emission on a single axis). Currently, the spheroid sound-emitting speaker cabinet of the present invention is believed to be best used to mount and enclose a single driver producing a single back wave. However, it might be possible to mount multiple drivers in a single cabinet if their back waves can be managed to complement each other inside the housing before being emitted from the spheroid cabinet.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention should accordingly be construed by what the above disclosure teaches and suggests to those skilled in the art, and by any claims that the above disclosure supports in this application or in any other application claiming priority to this application.

What is claimed is:

1. A speaker for playing audible sound comprising:
a speaker cabinet;
an electro-acoustic driver mounted in the cabinet for producing audible sound in response to electrical signals, the driver including a driver face mounted on and exposed from a driver-mounting face of the cabinet and a driver body enclosed in a substantially hollow interior of the cabinet, the driver capable of emitting a primary sound wave from the driver face and a back wave from the driver body; wherein,
the speaker cabinet comprises a substantially continuous spheroidal rear emitter wall spaced from and substantially surrounding the driver body and terminating at the driver-mounting face, the spheroidal rear emitter wall comprising an acoustic emitter material responsive to a back wave from the driver body to function as a secondary sound wave emitter and emit audible sound to a listening area around the speaker, the speaker cabinet further comprising a rigid support supporting the cabinet via the driver-mounting face such that the spheroidal rear emitter wall is substantially rigidly suspended in air spaced from surrounding surfaces in the listening area.

2. The speaker of claim 1, wherein the driver-mounting face is non-spheroidal.

3. The speaker of claim 2, wherein the driver-mounting face is substantially flat.

4. The speaker of claim 2, wherein the driver-mounting face is essentially coextensive with the driver face.

5. The speaker of claim 2, wherein the driver-mounting face is the only acoustically significant non-spheroidal surface on the cabinet.

6. The speaker of claim 5, wherein the spheroidal rear emitter wall has no acoustically significant flat surfaces.

7. The speaker of claim 2, wherein the driver-mounting face comprises an area extending beyond the driver face, and wherein the driver-mounting face substantially consists of an acoustically deadening material and is not an acoustic emitter surface.

8. The speaker of claim 7, wherein the speaker support comprises a rigid vertical cantilever support adapted to rest on a support surface such as a table, desk, or floor.

9. The speaker of claim 8, wherein the speaker support comprises a flat ring secured to the driver-mounting face of the cabinet, and wherein a peripheral portion of the driver face is mounted to the ring.

10. The speaker of claim 2, wherein the spheroidal rear emitter wall comprises approximately half or more of a spheroid.

11. The speaker of claim 1, wherein the speaker includes only one driver.

12. The speaker of claim 1, wherein the spheroidal rear emitter wall includes a port.

13. The speaker of claim 1, wherein the driver-mounting face comprises at least a portion of the speaker support.

14. A method for using the back wave from an electro-acoustic driver, comprising:
directing the back wave from the driver into the hollow interior of a cabinet having a spheroidal rear emitter wall whose surface functions as an acoustic emitter for the back wave, and supporting the cabinet from a driver-mounting face with a rigid support such that the spheroidal rear emitter wall is spaced from surrounding surfaces in the listening area.
